(19) United States
(12) Patent Application Publication
(10) Pub. No.: US 2026/0062341 A1
(43) Pub. Date: Mar. 5, 2026

(54) METAL SEALING GLASS

(71) Applicant: OHARA INC., Sagamihara-shi (JP)

(72) Inventor: Hirotaka Kobayashi, Sagamihara-Shi (JP)

(73) Assignee: OHARA INC., Sagamihara-shi (JP)

(21) Appl. No.: 19/310,001

(22) Filed: Aug. 26, 2025

(30) Foreign Application Priority Data
Aug. 27, 2024 (JP) 2024-145088
May 2, 2025 (JP) 2025-076819

(51) Int. Cl. C03C 3/093; C03C 27/02

(52) U.S. Cl. CPC C03C 3/093; C03C 27/02

(57) ABSTRACT

A metal sealing glass is disclosed with a high thermal expansion coefficient, reduced bubbles and striae and a high-water resistance. The metal sealing glass contains, in mass % in terms of oxides, equal to or more than 60.0% and equal to or less than 75.0% of the SiO₂ component, equal to or more than 9.0% and equal to or less than 18.0% of the B₂O₃ component, equal to or more than 3.0% and equal to or less than 9.0% of the Al₂O₃ component, equal to or more than 5.0% and equal to or less than 12.0% of the Na₂O component, equal to or more than 0% and equal to or less than 1.65% of the K₂O component with the thermal expansion coefficient of equal to or more than 60×10⁻⁷ K⁻¹ and equal to or less than 72×10⁻⁷ K⁻¹.

### CROSS-REFERENCE TO RELATED APPLICATIONS

This application claims the benefits of Japanese Patent Application No. 2024-145088 filed on Aug. 27, 2024 in the Japanese Patent Office and Japanese Patent Application No. 2025-076819 filed on May 2, 2025 in the Japanese Patent Office, the disclosures of which are herein incorporated in its entirety by reference.

### FIELD OF THE INVENTION

The present invention relates to a metal sealing glass with a high thermal expansion coefficient, and not only with reduced bubbles and striae but with a high-water resistance.

### BACKGROUND OF THE INVENTION

Japanese Laid-open patent publication No. S62-65954 discloses a borosilicate glass for alumina sealing that is especially suitable for applications of a window glass of an alumina package storing a solid-state image sensor such as a charge-coupled device (CCD) and a cap glass for a solid-state image sensor and thin film image sensor installed on an alumina substrate.

A highly reliable alumina ceramics is used for the package. As the package requires a window to pass through the light, a glass plate is sealed to the alumina package using glass frit. Also, a so-called contact image sensor has a thin film element, such as an amorphous silicon, attached or silicon chips aligned on an alumina ceramic substrate. In this case, the thin film element or solid-state element is covered with a cap glass, which is then hermetically sealed to the alumina substate using glass frit.

The glass used in this application should not crack, bend, or distort when sealed with alumina. In other words, the thermal expansion coefficients of the glass and alumina need to be compatible. Also, the light passing through the window and cap glass need to reach the image sensor without being distorted. Therefore, a high-quality glass with fewer defects, such as striae, bubbles, dig, and stains, is required.

Japanese Laid-open patent publication No. S62-65954 describes that a high-quality borosilicate glass for alumina sealing that is not only suitable for alumina sealing but is also uniform and with fewer defects is achievable by the composition described in the patent. However, the composition described in Japanese Laid-open patent publication No. S62-65954 has a high content of the K₂O component and therefore has a problem of low water resistance.

### Citation List

### Patent Literature

[Patent Literature 1] Japanese Laid-open patent publication No. S62-65954

### SUMMARY OF THE INVENTION

The purpose of the present invention is to provide a metal sealing glass with a high thermal expansion coefficient, and not only with reduced bubbles and striae but with a high-water resistance.

According to the present invention, there is provided a metal sealing glass of the following embodiment (constitution) containing, in mass % in terms of oxides, equal to or more than 60.0% and equal to or less than 75.0% of the SiO₂ component, equal to or more than 9.0% and equal to or less than 18.0% of the B₂O₃ component, equal to or more than 3.0% and equal to or less than 9.0% of the Al₂O₃ component, equal to or more than 5.0% and equal to or less than 12.0% of the Na₂O component, and equal to or more than 0% and equal to or less than 1.65% of the K₂O component, wherein the thermal expansion coefficient is equal to or more than 60×10⁻⁷ K⁻¹ and equal to or less than 72×10⁻⁷ K⁻¹.

According to the present invention, by adjusting the contents of the B₂O₃ and SiO₂ components, not only a metal sealing glass with a high thermal expansion coefficient and reduced bubbles and striae may be provided, but by adjusting the content of the K₂O component, a water resistance of the metal sealing glass may also be improved.

The present invention is used for a glass requiring properties of a high thermal expansion coefficient, reduced bubbles and striae, and a high-water resistance, for example, a window glass and a protective material for an electronic component.

### DESCRIPTION OF EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Hereinafter, the embodiments and examples of the present invention will be described in detail, but the present invention is not limited to the following embodiments and examples, and modifications may be made and implemented, as appropriate, within the scope of the objective of the present invention. In other words, the following embodiments and examples are just an example to ease understanding of the present invention and may be changed or modified without deviating from the spirit of the invention, and equivalents are of course included in the present invention.

The content of each component herein is indicated by mass % in terms of oxides unless otherwise described. Here, “mass % in terms of oxides” indicates an amount of an oxide of each component contained in a glass, in mass %, for when the total mass of the oxide is 100 mass %, assuming that all components forming the glass are decomposed and converted to oxides.

A metal sealing glass in the embodiment of the present invention contains, in mass % in terms of oxides, equal to or more than 60.0% and equal to or less than 75.0% of the SiO₂ component, equal to or more than 9.0% and equal to or less than 18.0% of the B₂O₃ component, equal to or more than 3.0% and equal to or less than 9.0% of the Al₂O₃ component, equal to or more than 5.0% and equal to or less than 12.0% of the Na₂O component, equal to or more than 0% and equal to or less than 1.65% of the K₂O component and has a thermal expansion coefficient equal to or more than 60×10⁻⁷ K⁻¹ and equal to or less than 72×10⁻⁷ K⁻¹.

A composition range for each component that forms a metal sealing glass for the embodiment of the present invention is described in detail below.

A SiO₂ component is the main component of a metal sealing glass in the embodiment of the present invention and is the basic component of a glass structure.

If the content of the SiO₂ component exceeds 75.0%, a molten liquid is likely to become more viscous, and glass formation becomes harder. Also, more bubbles and striae are likely to be formed reducing the quality of the glass. Therefore, the upper limit for the content of the SiO₂ component is preferably equal to or less than 75.0%, equal to or less than 74.0%, equal to or less than 72.0%, or equal to or less than 70.0%.

Moreover, if the content of the SiO₂ component is less than 60.0%, the thermal expansion coefficient becomes larger, and the glass becomes susceptible to break when in contact with a metal. Also, the water resistance of the glass deteriorates. Furthermore, the glass tends to devitrify. Therefore, the lower limit for the content of the SiO₂ component is preferably equal to or more than 60.0%, equal to or more than 61.0%, equal to or more than 62.0%, equal to or more than 63.0%, equal to or more than 64.0%, or equal to or more than 65.0%.

A B₂O₃ component improves a melting performance of a glass and is an ideal component to reduce the viscosity of a molten liquid.

By having the content of the B₂O₃ component equal to or less than 18.0%, a reduction in the thermal expansion coefficient can be prevented, and the viscosity of the molten liquid can be reduced. Therefore, the upper limit for the content of the B₂O₃ component is preferably equal to or less than 18.0%, equal to or less than 17.0%, equal to or less than 16.0%, equal to or less than 15.0%, equal to or less than 14.6%, or equal to or less than 14.0%.

Moreover, by increasing the content of the B₂O₃ component to equal to or more than 9.0%, the melting performance of the glass can be improved. Therefore, the lower limit for the content of the B₂O₃ component is preferably equal to or more than 9.0%, equal to or more than 10.0%, equal to or more than 11.0%, equal to or more than 12.0%, or equal to or more than 13.0%.

An Al₂O₃ component is an ideal component to improve water resistance and to prevent devitrification of a glass.

If the content of the Al₂O₃ component exceeds 9.0%, a melting performance of the glass deteriorates. Therefore, the upper limit for the content of the Al₂O₃ component is preferably equal to or less than 9.0%, equal to or less than 8.0%, equal to or less than 7.0%, or equal to or less than 6.0%.

Moreover, if the content of the Al₂O₃ component is less than 3.0%, it becomes harder to improve the water resistance, and the glass tends to devitrify. Therefore, the lower limit for the content of the Al₂O₃ component is preferably equal to or more than 3.0%, equal to or more than 4.0%, or equal to or more than 5.0%.

A Na₂O component improves a melting performance of a glass and is effective in decreasing a melting point for when the glass is melting.

If the content of the Na₂O component exceeds 12.0%, the water resistance of the glass deteriorates. Therefore, the upper limit for the content of the Na₂O component is preferably equal to or less than 12.0%, equal to or less than 11.5%, equal to or less than 11.0%, equal to or less than 10.0%, or equal to or less than 9.0%.

Moreover, if the content of the Na₂O component is less than 5.0%, the melting performance deteriorates. Therefore, the lower limit for the content of the Na₂O component is preferably equal to or more than 5.0%, equal to or more than 6.0%, equal to or more than 7.0%, or equal to or more than 8.0%.

A K₂O component is a component that improves water resistance and melting performance of a glass, as well as a component that increases a thermal expansion coefficient.

By having the content of the K₂O component equal to or less than 1.65%, the water resistance of the glass can be improved. Therefore, the upper limit for the content of the K₂O component is preferably equal to or less than 1.65%, equal to or less than 1.5%, equal to or less than 1.4%, or equal to or less than 1.3%.

Moreover, by including the K₂O component in the glass structure, the water resistance and melting performance can be improved, and the thermal expansion coefficient can also be increased. The lower limit for the content of the K₂O component is preferably equal to or more than 0%, equal to or more than 0.5%, equal to or more than 0.6%, or equal to or more than 1.0%.

A MgO component is an ideal component to improve water resistance of a glass.

If the content of the MgO component exceeds 5.0%, the glass tends to devitrify, and water resistance is more likely to deteriorate. Therefore, the upper limit for the content of the MgO component is preferably equal to or less than 5.0%, equal to or less than 4.0%, equal to or less than 3.0%, or equal to or less than 2.0%.

Moreover, by including the MgO component in the glass structure, the melting performance and water resistance of the glass can be improved, and devitrification can be prevented. The lower limit for the content of the MgO component is preferably equal to or more than 0%, equal to or more than 0.1%, equal to or more than 0.2%, equal to or more than 0.3%, or equal to or more than 0.4%.

A CaO component is an ideal component to improve water resistance of a glass.

If the content of the CaO component exceeds 4.0%, the glass tends to devitrify, and water resistance is likely to deteriorate. Therefore, the upper limit for the content of the CaO component is preferably equal to or less than 4.0%, equal to or less than 3.0%, or equal to or less than 2.0%.

Moreover, by including the CaO component in the glass structure, the melting performance and water resistance of the glass can be improved, and the devitrification can be prevented. The lower limit for the content of the CaO component is preferably equal to or more than 0%, equal to or more than 0.5%, or equal to or more than 0.8%.

A BaO component is an ideal component to prevent a phase separation and to improve water resistance of a glass.

If the content of the BaO component exceeds 6.0%, the glass tends to devitrify, and water resistance is more likely to deteriorate. Therefore, the upper limit for the content of the BaO component is preferably equal to or less than 6.0%, equal to or less than 5.0%, equal to or less than 4.0%, or equal to or less than 3.0%.

Moreover, by including the BaO component in the glass structure, the melting performance and water resistance of the glass can be improved. The lower limit for the content of the BaO component is preferably equal to or more than 0%, equal to or more than 1.0%, equal to or more than 1.5%, or equal to or more than 2.0%.

A ZnO component is a component to prevent evaporation of the B₂O₃ and alkaline components.

If the content of the ZnO component exceeds 6.0%, the glass tends to devitrify, and the B₂O₃ and alkaline components are more likely to evaporate. Therefore, the upper limit for the content of the ZnO component is preferably equal to or less than 6.0%, equal to or less than 4.0%, equal to or less than 2.0%, or equal to or less than 1.0%.

Moreover, by including the ZnO component in the glass structure, the melting performance and chemical durability of the glass can be improved. Also, coloring of the glass can be reduced. The lower limit for the content of the ZnO component is preferably equal to or more than 0%, equal to or more than 0.2%, equal to or more than 0.4%, or equal to or more than 0.5%.

An Sb₂O₃ component is a component that is effective in facilitating defoaming and refining in the glass.

If the content of the Sb₂O₃ component exceeds 2.0%, alloying with other metals is likely to occur, and the internal quality is more likely to decline by formation such as microcrystal. Therefore, the upper limit for the content of the Sb₂O₃ component is preferably equal to or less than 2.0%, equal to or less than 1.0%, or equal to or less than 0.5%.

Moreover, by including the Sb₂O₃ component in the glass structure, deforming effect can be facilitated. The lower limit for the content of the Sb₂O₃ component is preferably equal to or more than 0%, equal to or more than 0.1%, or equal to or more than 0.15%.

Furthermore, as other optional component, the content of a Li₂O component may be equal to or more than 0% and less than 0.5%, more specifically equal to or more than 0% and equal to or less than 0.3%.

A mass ratio of B₂O₃/K₂O is preferably equal to or more than 9.0 and equal to or less than 15.0.

By adjusting the contents of the B₂O₃ and/or K₂O components within the abovementioned range and setting the mass ratio equal to or more than 9.0 and equal to or less than 15.0, a viscosity of the glass can be reduced, and the glass formation becomes easier. Also, the glass can be manufactured without deteriorating the chemical durability.

Therefore, the upper limit for the mass ratio of B₂O₃/K₂O is preferably equal to or less than 15.0, more preferably equal to or less than 14.0, even more preferably equal to or less than 13.5, even more preferably equal to or less than 12.0. Moreover, the lower limit for the mass ratio of B₂O₃/K₂O is preferably equal to or more than 9.0, more preferably equal to or more than 10.0.

A mass ratio of SiO₂/K₂O is preferably equal to or more than 45.0 and equal to or less than 65.0.

By adjusting the contents of the SiO₂ and/or K₂O components within the abovementioned range and setting the mass ratio equal to or more than 45.0 and equal to or less than 65.0, the melting temperature of the glass is reduced, and it becomes easier to melt the glass. Also, the glass can be manufactured without deteriorating the chemical durability.

Therefore, the upper limit for the mass ratio of SiO₂/K₂O is preferably equal to or less than 65.0, more preferably equal to or less than 63.0, even more preferably equal to or less than 62.0, even more preferably equal to or less than 60.0. Moreover, the lower limit for the mass ratio of SiO₂/K₂O is preferably equal to or more than 45.0, more preferably equal to or more than 47.0, even more preferably equal to or more than 50.0, even more preferably equal to or more than 53.0.

A mass ratio of (B₂O₃+SiO₂)/K₂O is preferably equal to or more than 53.5 and equal to or less than 80.0.

By selecting one or more selected from the group consisting of the contents of the SiO₂, B₂O₃, and K₂O components and adjusting these within the abovementioned range to make the mass ratio equal to or more than 53.5 and equal to or less than 80.0, a glass with a high thermal expansion coefficient can be obtained.

Therefore, the upper limit for the mass ratio of (B₂O₃+SiO₂)/K₂O is preferably equal to or less than 80.0, more preferably equal to or less than 76.0, even more preferably equal to or less than 70.0, even more preferably equal to or less than 67.0. Also, the lower limit for the mass ratio of (B₂O₃+SiO₂)/K₂O is preferably equal to or more than 53.5, more preferably equal to or more than 56.0, even more preferably equal to or more than 60.0, even more preferably equal to or more than 64.0.

The upper limit for the thermal expansion coefficient (×10⁻⁷ K⁻¹) of the metal sealing glass in the embodiment of the present invention is preferably equal to or less than 72×10⁻⁷ K⁻¹, more preferably equal to or less than 71×10⁻⁷ K⁻¹, even more preferably equal to or less than 70×10⁻⁷ K⁻¹, even more preferably equal to or less than 69×10⁻⁷ K⁻¹, even more preferably equal to or less than 68×10⁻⁷ K⁻¹, even more preferably equal to or less than 67×10⁻⁷ K⁻¹. Also, the lower limit for the thermal expansion coefficient is preferably equal to or more than 60×10⁻⁷ K⁻¹, more preferably equal to or more than 62×10⁻⁷ K⁻¹, or even more preferably equal to or more than 63×10⁻⁷ K⁻¹. By increasing the thermal expansion coefficient like this, it becomes easier for the glass to seal with a metal, and a stable metal sealing glass can be manufactured. It should be noted that the thermal expansion coefficient is a value that is measured and calculated by the method described in the examples later.

A water resistance is an indicator of how easy a clouding is formed on a glass surface and is determined by calculating a percentage of weight loss of a glass sample (wt. %) before and after treating with a reagent and classifying into grades. The smaller the percentage of weight loss of a glass sample before and after treating with a reagent, the higher the water resistance of the glass tends to be. Therefore, the percentage of weight loss of a glass sample for the metal sealing glass in the embodiment of the present invention before and after treating with the reagent is preferably less than 0.05wt. %, more preferably equal to or less than 0.01wt. %. It should be noted that the percentage of weight loss is a value that is measured and calculated by the method described in the examples later.

### EXAMPLES

### Examples 1 to 5

### 1. Manufacturing of Metal Sealing Glass

A raw material of the equivalent oxide, hydroxide, carbonate, nitrate and so on was each selected as a raw material for each component for the metal sealing glass, and these raw materials were weighed so as to make up a composition described in Table 1 below and were homogeneously mixed.

Then, the mixed raw material was put into a platinum crucible and was heated and melted at 1350 to 1450 degrees centigrade for 2 to 24 hours using an electric furnace. Then, the molten glass was stirred to homogenize, cooled to 1400 degrees centigrade, poured into a mold, and slowly cooled (annealing treatment) to obtain a glass.

### 2. Evaluation Method for Metal Sealing Glass

The following properties were measured for the obtained glass. The results are shown in Table 1 below.

### (1) Thermal Expansion Coefficient

A thermal expansion coefficient was measured in accordance with Japan Optical Glass Industrial Standard (JOGIS) JOGIS 16:2019 “Measuring Method for Average Linear Thermal Expansion Coefficient of Optical Glass at Normal Temperature” and JOGIS 08:2019 “Measuring Method for Thermal Expansion of Optical Glass”. It should be noted that in the embodiment of the present invention, the thermal expansion coefficient was obtained from a thermal expansion curve of a glass.

### (2) Specific Gravity

A specific gravity is a ratio of a density of each glass type after annealing to the density of pure water at 1 atm and 4 degrees centigrade. In accordance with a measurement method of JIS Z 8807:2012 “Methods of Measuring Density and Specific Gravity of Solid”, a glass sample was weighed in air and water, and the obtained density was divided by a density of water to calculate a specific gravity.

### (3) Water Resistance

Using the glasses of examples 1 to 5, water resistance was measured in accordance with JOGIS 06:2019 “Measuring Method for Chemical Durability of Optical Glass (Powder Method)”. Specifically, a glass sample with a size that can pass through a 600 μm test sieve but remain on a 425 μm test sieve was weighed equivalent to the specific gravity in grams in a platinum basket. Then, the weighed sample was put into a glass round-bottom flask containing an aqueous solution of 0.01 N nitric acid and was treated in a boiling water bath for 60 minutes. After treating, a mass loss (wt. %) of the glass sample was calculated to obtain a percentage of the weight loss (wt. %).

### Comparative Example 1

The composition and physical properties of the sample No. 5 cited in Japanese Laid-open patent publication No. S62-65954 are shown in Table 1 as a comparative example 1. The sample has a low water resistance as the content of the K₂O component is high.

TABLE 1

| | | Example | Example | Example | Example | Example | Comparative |
|---|---|---|---|---|---|---|---|
| | Component | 1 | 2 | 3 | 4 | 5 | example 1 |
| Composition | SiO₂ | 69.15 | 67.95 | 65.95 | 67.36 | 67.36 | 70.9 |
| [wt. %] | B₂O₃ | 10.80 | 12.00 | 14.00 | 14.58 | 14.58 | 11.4 |
| | Na₂O | 8.60 | 8.60 | 8.60 | 11.16 | 11.16 | 6.5 |
| | Al₂O₃ | 5.90 | 5.90 | 5.90 | 5.39 | 5.39 | 4.4 |
| | Li₂O | — | — | — | — | 0.19 | 0.5 |
| | K₂O | 1.20 | 1.20 | 1.20 | 1.09 | 1.09 | 2.3 |
| | CaO | 0.80 | 0.80 | 0.80 | — | — | 0.5 |
| | BaO | 2.50 | 2.50 | 2.50 | — | — | 1.5 |
| | ZnO | 0.60 | 0.60 | 0.60 | — | — | 2.0 |
| | MgO | 0.40 | 0.40 | 0.40 | — | — | — |
| | Sb₂O₃ | 0.08 | 0.20 | 0.20 | 0.23 | 0.23 | — |
| | Total | 100.15 | 100.15 | 100.15 | 99.81 | 100.00 | 97.2 |
| Composition | B₂O₃/K₂O | 9.00 | 10.00 | 11.67 | 13.38 | 13.38 | — |
| ratio | SiO₂/K₂O | 57.63 | 56.63 | 54.96 | 61.80 | 61.80 | — |
| | (B₂O₃ + SiO₂)/K₂O | 66.63 | 66.63 | 66.63 | 75.17 | 75.17 | — |

| | | | | | | |
|---|---|---|---|---|---|---|
| Thermal expansion coefficient | 64 | 62 | 63 | 68 | 70 | 62.1 |
| [×10⁻⁷ K⁻¹] | | | | | | |
| Specific gravity | 2.43 | 2.43 | 2.42 | 2.40 | 2.41 | — |
| Percentage of weight loss | Less | Less | 0.01 | Less | 0.01 | 0.06 |
| [wt. %] | than 0.01 | than 0.01 | | than 0.01 | | |

The present invention includes the following embodiments (constitutions).

### Constitution 1

A metal sealing glass comprising, in mass % in terms of oxides, equal to or more than 60.0% and equal to or less than 75.0% of the SiO₂ component, equal to or more than 9.0% and equal to or less than 18.0% of the B₂O₃ component, equal to or more than 3.0% and equal to or less than 9.0% of the Al₂O₃ component, equal to or more than 5.0% and equal to or less than 12.0% of the Na₂O component, equal to or more than 0% and equal to or less than 1.65% of the K₂O component, wherein the thermal expansion coefficient is equal to or more than 60×10⁻⁷ K⁻¹ and equal to or less than 72×10⁻⁷ K⁻¹.

### Constitution 2

The metal sealing glass according to constitution 1 comprising, in mass % in terms of oxides, equal to or more than 0% and equal to or less than 4.0% of the Cao component, equal to or more than 0% and equal to or less than 6.0% of the BaO component, equal to or more than 0% and equal to or less than 6.0% of the Zno component, equal to or more than 0% and equal to or less than 5.0% of the MgO component, and equal to or more than 0% and equal to or less than 2.0% of the Sb₂O₃ component.

### Constitution 3

The metal sealing glass according to constitution 1 or 2, wherein the mass ratio of B₂O₃/K₂O, in mass % in terms of oxides, is equal to or more than 9.0 and equal to or less than 15.0.

### Constitution 4

The metal sealing glass according to any one of constitutions 1 to 3, wherein the mass ratio of SiO₂/K₂O, in mass % in terms of oxides, is equal to or more than 45.0 and equal to or less than 65.0.

### Constitution 5

The metal sealing glass according to any one of constitutions 1 to 4, wherein the mass ratio of (B₂O₃30 SiO₂)/K₂O, in mass % in terms of oxides, is equal to or more than 53.5 and equal to or less than 80.0.

1. A metal sealing glass comprising, in mass % in terms of oxides,
equal to or more than 60.0% and equal to or less than 75.0% of a SiO₂ component;
equal to or more than 9.0% and equal to or less than 18.0% of a B₂O₃ component;
equal to or more than 3.0% and equal to or less than 9.0% of an Al₂O₃ component;
equal to or more than 5.0% and equal to or less than 12.0% of a Na₂O component;
equal to or more than 0% and equal to or less than 1.65% of a K₂O component;
wherein the thermal expansion coefficient is equal to or more than 60×10⁻⁷ K⁻¹ and equal to or less than 72×10⁻⁷ K⁻¹.

2. The metal sealing glass according to claim 1 comprising, in mass % in terms of oxides, equal to or more than 0% and equal to or less than 4.0% of a CaO component;
equal to or more than 0% and equal to or less than 6.0% of a BaO component;
equal to or more than 0% and equal to or less than 6.0% of a ZnO component;
equal to or more than 0% and equal to or less than 5.0% of a MgO component; and
equal to or more than 0% and equal to or less than 2.0% of a Sb₂O₃ component.

3. The metal sealing glass according to claim 1, wherein the mass ratio of B₂O₃/K₂O, in mass % in terms of oxides, is equal to or more than 9.0 and equal to or less than 15.0.

4. The metal sealing glass according to claim 1, wherein the mass ratio of SiO₂/K₂O, in mass % in terms of oxides, is equal to or more than 45.0 and equal to or less than 65.0.

5. The metal sealing glass according to claim 1, wherein the mass ratio of (B₂O₃+SiO₂)/K₂O, in mass % in terms of oxides, is equal to or more than 53.5 and equal to or less than 80.0.

6. The metal sealing glass according to claim 2, wherein the mass ratio of B₂O₃/K₂O, in mass % in terms of oxides, is equal to or more than 9.0 and equal to or less than 15.0.

7. The metal sealing glass according to claim 2, wherein the mass ratio of SiO₂/K₂₀, in mass % in terms of oxides, is equal to or more than 45.0 and equal to or less than 65.0.

8. The metal sealing glass according to claim 2, wherein the mass ratio of (B₂O₃+SiO₂)/K₂O, in mass % in terms of oxides, is equal to or more than 53.5 and equal to or less than 80.0.
